(19) United States
(12) Patent Application Publication
(10) Pub. No.: US 2020/0282807 A1
(43) Pub. Date: Sep. 10, 2020

(54) HEAT-LOSS MANAGEMENT SYSTEM FOR VEHICLE AND CONTROL METHOD THEREOF

(71) Applicants: HYUNDAI MOTOR COMPANY, Seoul (KR); KIA MOTORS CORPORATION, Seoul (KR); Hanon Systems, Daejeon (KR)

(72) Inventors: Dong Ho KWON, Yongin-si (KR); Gee Young SHIN, Suwon-si (KR); Dae Ig JUNG, Suwon-si (KR); Seung Hyeok CHANG, Suwon-si (KR); Jeong Hoon LEE, Daejeon (KR); Joong Jae KIM, Daejeon (KR)

(73) Assignees: HYUNDAI MOTOR COMPANY, Seoul (KR); KIA MOTORS CORPORATION, Seoul (KR); Hanon Systems, Daejeon (KR)

(21) Appl. No.: 16/527,904

(22) Filed: Jul. 31, 2019

(30) Foreign Application Priority Data
Mar. 8, 2019 (KR) 10-2019-0027178

(51) Int. Cl. B60H 1/00

(52) U.S. Cl. CPC B60H 1/00985; B60H 1/0073; B60H 1/00792; B60H 1/00764

(57) ABSTRACT

A heat-loss management system for a vehicle and a control method thereof, which are capable of identifying a heat-insulation degree at a specific point in the vehicle so as to maintain or repair the heat-insulation performance of the vehicle.

### CROSS REFERENCE TO RELATED APPLICATION

The present application claims priority to and the benefit of Korean Patent Application Number 10-2019-0027178, filed on Mar. 8, 2019, the entire contents of which are incorporated herein by reference.

### FIELD

The present disclosure relates to a heat-loss management system for a vehicle and a control method thereof, which are capable of identifying a heat-insulation degree in the vehicle.

### BACKGROUND

The statements in this section merely provide background information related to the present disclosure and may not constitute prior art.

Most vehicles are provided with an air conditioner to raise or lower an indoor-air temperature for the thermal comfort of a passenger. The air conditioner raises or lowers the temperature in the vehicle through heat exchange between outdoor air or indoor air. In this process, thermal energy is consumed.

On the one hand, even if the indoor-air temperature reaches a temperature set by a passenger using the air conditioner, heat insulation between the inside and the outside of the vehicle is not perfect, so that heat transfer between the inside and the outside is inevitable. Moreover, there is no method or procedure for determining the heat-insulation performance of the vehicle after the vehicle has been released. Thus, even if the heat-insulation performance is deteriorated later, a vehicle owner does not recognize the deterioration in performance, so that the thermal efficiency of the air conditioner may be continuously reduced.

The foregoing is intended merely to aid in the understanding of the background of the present disclosure, and is not intended to mean that the present disclosure falls within the purview of the related art that is already known to those skilled in the art.

### SUMMARY

The present disclosure proposes a heat-loss management system for a vehicle and a control method thereof, which are capable of identifying a heat-insulation degree at a specific point in the vehicle so as to maintain or repair the heat-insulation performance of the vehicle.

According to one aspect, a heat-loss management system for a vehicle may include: a point calculating unit configured to calculate a target temperature that is a temperature at a specific point in the vehicle; an outdoor-air calculating unit configured to calculate an outdoor-air temperature of the vehicle; a vehicle-speed calculating unit configured to calculate a vehicle speed; a data unit configured to store comparative temperature values corresponding to specific points and determined based on the outdoor-air temperature of the vehicle and the vehicle speed; and a control unit configured to: extract, through the data unit, a comparative temperature value among the stored comparative temperature values based on the calculated outdoor-air temperature and vehicle speed; compare the extracted comparative temperature value with the calculated target temperature; determine a heat-insulation degree at the specific point inside of the vehicle.

The heat-loss management system may further include an indoor-air calculating unit configured to calculate an indoor-air temperature of the vehicle, wherein the comparative temperature values are determined based on the outdoor-air temperature, the calculated indoor-air temperature of the vehicle and the vehicle speed, and the control unit may compare the stored comparative temperature values with the target temperature calculated through the point calculating unit, thus determining a heat-insulation degree at a specific point in the vehicle.

The control unit may be operated when the indoor-air temperature may be equal to a preset temperature.

The control unit may be operated when the vehicle speed may be equal to or less than a predetermined speed.

The data unit may store comparative temperature values in an initial release state of the vehicle.

The control unit may determine that heat-insulation performance may be deteriorated when a difference between the calculated target temperature and the extracted comparative temperature value may be equal to or more than a preset level.

The control unit may determine that heat-insulation performance is deteriorated when a case where the difference between the target temperature and the comparative temperature value is equal to or more than the preset level is detected a predetermined times or more.

The heat-loss management system may further include an alarm unit configured to provide information for a user of the vehicle, wherein the control unit may give an alarm to a passenger of the vehicle through the alarm unit, when it may be determined that the heat-insulation performance may be deteriorated.

The point calculating unit may calculate target temperatures of a door joint or a door glass or a front pillar or a middle pillar or a rear pillar or a windshield or a head lining or a sunroof of the vehicle.

According to another aspect, a method of controlling a heat-loss management system for a vehicle may include: calculating an outdoor-air temperature of the vehicle and a vehicle speed through an outdoor-air calculating unit and a vehicle-speed calculating unit; deriving a comparative temperature value, among comparative temperature values stored in a memory, based on the calculated outdoor-air temperature and vehicle speed; calculating a target temperature through a point calculating unit; and determining a heat-insulation degree at a specific point inside of the vehicle by comparing the derived comparative temperature value with the calculated target temperature in a control unit.

According to the present disclosure, the heat-loss management system for a vehicle and the control method thereof are capable of identifying a heat-insulation degree at a specific point in the vehicle so as to maintain or repair the heat-insulation performance of the vehicle.

Particularly, it is advantageous in that it is possible to continuously check the heat-insulation performance of the vehicle after the vehicle has been released.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a diagram illustrating the configuration of a heat-loss management system for a vehicle;

FIGS. 2 and 3 are flowcharts of the heat-loss management system for the vehicle, and

FIG. 4 is a diagram illustrating points where heat exchange may occur in the vehicle for the purpose of aiding in understanding the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Hereinbelow, exemplary foils of the present disclosure will be described in detail with reference to the accompanying drawings.

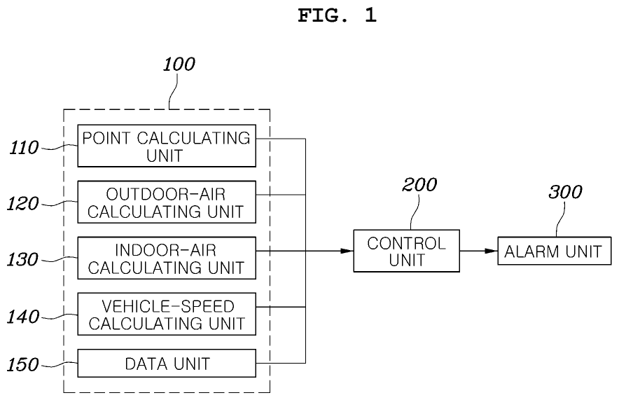

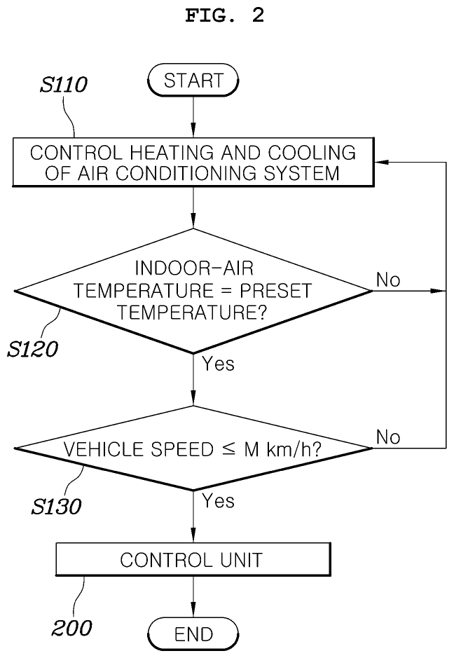

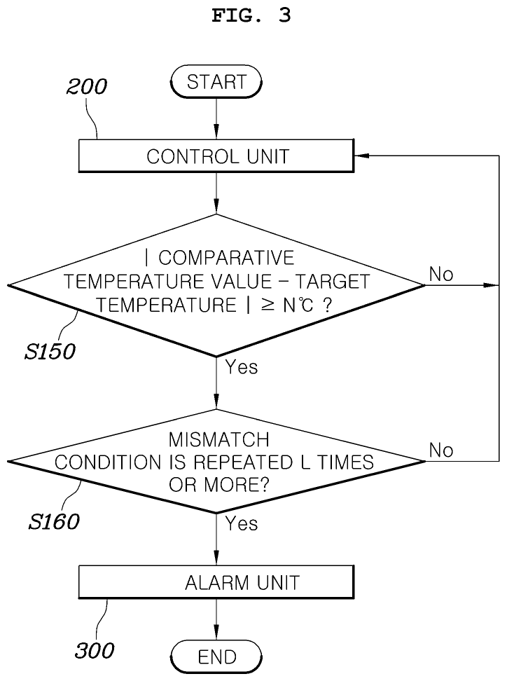

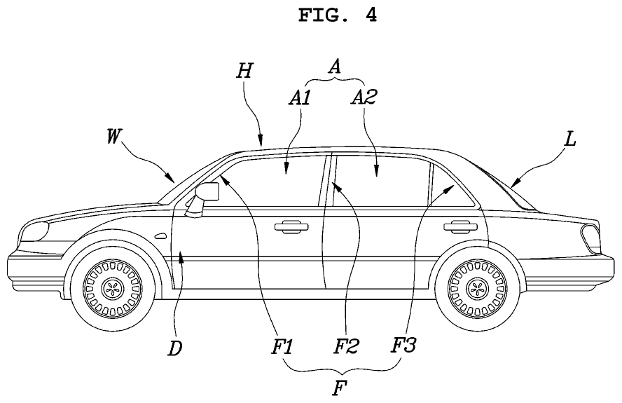

FIG. 1 is a diagram illustrating the configuration of a heat-loss management system for a vehicle in accordance with one form of the present disclosure, FIGS. 2 and 3 are flowcharts of the heat-loss management system for the vehicle in accordance with exemplary forms of the present disclosure, and FIG. 4 is a diagram illustrating points where heat exchange may occur in the vehicle for the purpose of aiding in understanding the present disclosure.

According to the present disclosure, the heat-loss management system is provided to predict or prevent deterioration in thermal efficiency of an air conditioner for the vehicle due to a reduction in heat insulation rate between the outside space and the inside space of the vehicle at a specific point inside of the vehicle.

FIG. 4 is a diagram illustrating points where heat exchange may occur in the vehicle for the purpose of aiding in understanding the present disclosure. As illustrated in FIG. 4, heat exchange is performed between the outside space and the inside space at respective points of the vehicle, including a front shield glass W constituting a front glass of the vehicle, a door joint D provided on a vehicle side to be connected with a vehicle body, a door glass A constituting a side glass of the vehicle, a pillar F constituting a side of the vehicle body, a rear shield glass L constituting a rear glass of the vehicle, a head lining H or sunroof constituting a roof of the vehicle body and the like. A heat-insulation process of preventing heat exchange is performed when the vehicle is released, but a heat insulation rate is gradually reduced depending on the frequency or condition of use of the vehicle. So, the system of the present disclosure determines a place where the heat insulation rate is lowered at the respective points of the vehicle.

As illustrated in FIG. 1, the heat-loss management system for the vehicle according to one foam of the present disclosure includes: a point calculating unit 110 configured to calculate a target temperature that is a temperature at a specific point in the vehicle, an outdoor-air calculating unit 120 configured to calculate an outdoor-air temperature of the vehicle, a vehicle-speed calculating unit 140 configured to calculate a vehicle speed, a data unit 150 configured to store comparative temperature values at specific points matched with the outdoor-air temperature of the vehicle and the vehicle speed, and a control unit 200 configured to derive, through the data unit, a comparative temperature value corresponding to the outdoor-air temperature of the vehicle and the vehicle speed calculated through the outdoor-air calculating unit 120 and the vehicle-speed calculating unit 140, and to compare the derived comparative temperature value with the target temperature calculated through the point calculating unit 110, thus determining a heat-insulation degree at a specific point in the vehicle.

To be more specific, the system further includes an indoor-air calculating unit 130 configured to calculate an indoor-air temperature of the vehicle. The data unit 150 stores comparative temperature values at specific points matched with the outdoor-air temperature, the indoor-air temperature of the vehicle and the vehicle speed. The control unit 200 compares the stored comparative temperature value with the target temperature calculated through the point calculating unit 110, thus determining a heat-insulation degree at a specific point in the vehicle.

The heat-loss management system is provided with an input unit 100. The input unit 100 includes the point calculating unit 110, the vehicle-speed calculating unit 140, the outdoor-air calculating unit 120, the indoor-air calculating unit 130, and the data unit 150. The input unit 100 compares and processes the input information, thus determining the heat-insulation performance at a specific point in the vehicle.

According to one form of the present disclosure, the point calculating unit 110 is provided with a sensor having a thermal sensing function, such as an infrared sensor. The point calculating unit 110 measures the target temperature that is a temperature at a specific point in the vehicle, and information on the target temperature is compared with the comparative temperature value stored in the data unit 150 to serve as a standard for determining the heat-insulation degree at a specific point in the vehicle. Furthermore, the vehicle-speed calculating unit 140 may include a GPS, an ultrasonic sensor or the like, thus calculating the vehicle speed. The outdoor-air calculating unit 120 is provided with a sensor having a thermal sensing function, such as an infrared sensor, thus measuring the outdoor-air temperature of the vehicle, or is provided with a GPS or the like, thus calculating the outdoor-air temperature at a point where the vehicle is being driven. Furthermore, the indoor-air calculating unit 130 may calculate the indoor-air temperature of the vehicle through a sensor having a thermal sensing function, such as an infrared sensor, or a thermometer.

Furthermore, comparative temperature values at specific points matched with the outdoor-air temperature, the indoor-air temperature of the vehicle and the vehicle speed are stored in the data unit 150. The data unit 150 may employ a memory storage medium of a micro controller unit (MCU) or the like. The comparative temperature values at respective specific points in the vehicle matched with the outdoor-air temperature, the indoor-air temperature of the vehicle and the vehicle speed, respectively, are stored in the data unit 150. The control unit 200 may employ a CPU core of the micro controller unit (MCU) or the like. By comparing the comparative temperature value stored in the data unit 150 with the target temperature calculated through the point calculating unit 110, the control unit 200 may determine that heat is not properly shielded and thus a heat insulation ability is deteriorated at a specific point in the vehicle if the comparative temperature value is different from the target temperature value. For example, in the case where the comparative temperature value at a specific point is stored as 25° C. in the data unit 150 under certain circumstances (specific outdoor-air temperature, indoor-air temperature and vehicle speed), if the target temperature at a specific point in the vehicle calculated in the point calculating unit 110 is 20° C., it can be seen that heat-insulation performance is deteriorated between the outside and the inside of the vehicle at a specific point.

As illustrated in FIG. 2, the control unit 200 in one form of the present invention may be operated when the indoor-air temperature is equal to the preset temperature at step S120. First, if the heating and cooling of an air conditioning system is controlled at step 110 when the vehicle is driven, the indoor-air temperature reaches a preset temperature that is set by a user. In this case, if the heat-insulation performance of the vehicle is deteriorated while the indoor-air temperature is maintained at the preset temperature, a large quantity of thermal energy is additionally put into the air conditioner. Thus, when the indoor-air temperature is equal to the preset temperature, the heat-insulation degree at a specific point in the vehicle is determined.

Furthermore, as illustrated in FIG. 2, the control unit 200 may be operated when the vehicle speed is equal to or less than a predetermined speed at step S130. The lower the vehicle speed is, the lower the effects of a temperature change due to wind speed are. Thus, the control unit may be operated only at or below a predetermined speed (M km/h) at which the effects of the temperature change due to the wind speed are low so as to accurately determine a reduction in heat insulation rate.

If the vehicle speed is equal to or less than M km/h, the control unit 200 is operated. The value of M may be differently set depending on the type of the vehicle and the specific point in the vehicle.

Moreover, according to one form of the present disclosure, comparative temperature values determined in the initial release state of the vehicle may be stored in the data unit 150 (e.g., a memory). In the initial release state of the vehicle (e.g., when a new vehicle is manufactured in a factory), specific points in the vehicle are properly insulated. In this initial release state, the comparative temperature value of each specific point is determined and stored based on the specific outdoor-air temperature of the vehicle, the specific indoor-air temperature of the vehicle, and/or the specific speed of the vehicle. This comparative temperature value is measured by an experiment or the like and then is stored in the data unit. Thus, by comparing the stored comparative temperature value in the initial release state of the vehicle with a target temperature value at a current specific point, it may be determined whether the heat insulation performance is deteriorated or not.

As illustrated in FIG. 3, the control unit 200 may determine that the heat-insulation performance is deteriorated when a difference between the target temperature and the comparative temperature value is equal to or more than a predetermined level at step S150.

The difference between the target temperature and the comparative temperature value is calculated as an absolute value, and a difference value at which it is determined that the heat-insulation performance is deteriorated may be set differently depending on the type of a vehicle.

If |comparative temperature—target temperature|≥N° C., the control unit 200 is operated to determine that the heat-insulation performance is deteriorated. The N value may be set differently depending on the type of a vehicle and a specific point in the vehicle.

To be more specific, as illustrated in FIG. 3, the control unit 200 may determine that the heat-insulation performance is deteriorated when a case where a difference between the target temperature and the comparative temperature value is equal to or more than a predetermined level is detected a predetermined times or more at step S160.

In FIG. 3, “mismatch condition is repeated L times or more” is represented. The term “mismatch condition” means that the target temperature and the comparative temperature are not equal to each other but have a difference of a predetermined level or more.

The target temperature and the comparative temperature may not be matched with each other due to heat interference caused by a passenger's body when the vehicle is driven. In such a case, the control unit may experience an error to determine that the heat insulation ability is lowered. Therefore, when the control unit of the present disclosure detects the case where the difference between the target temperature and the comparative temperature value is equal to or more than a predetermined level more than or equal to a predetermined times (L times), it may be determined that the heat-insulation performance is deteriorated.

The L value of the mismatch condition may be set differently depending on the type of a vehicle, the internal structure of the vehicle, and a specific point in the vehicle.

Furthermore, as illustrated in FIGS. 1 and 3, the heat-loss management system for the vehicle according to one form of the present disclosure further includes an alarm unit 300 configured to provide information for a user of the vehicle. The control unit 200 gives an alarm to a passenger of the vehicle through the alarm unit 300, when it is determined that the heat-insulation performance is deteriorated.

The alarm unit 300 may be composed of a display, a speaker or the like, and may inform the passenger, through a message, a voice or the like, that the heat insulation ability is lowered at a specific point in the vehicle.

Thereby, the passenger of the vehicle may recognize that the current heat-insulation ability of the vehicle is deteriorated, and the thermal efficiency of the vehicle may be enhanced through maintenance or repairs.

Meanwhile, the point calculating unit may calculate the target temperatures of the door joint D or the door glass A or the front pillar F1 or the middle pillar F2 or the rear pillar F3 or the front shield glass W or the rear shield glass L or the head lining H or the sunroof of the vehicle of FIG. 1.

The door glass A includes a front door glass A1 and a rear door glass A2. The point calculating unit 110 may calculate the target temperatures of the front door glass A1 and the rear door glass A2, respectively.

The pillar F is a vehicle-body structure constituting the side of the vehicle, and is composed of the front pillar F1, the middle pillar F2 and the rear pillar F3.

The point calculating unit 110 may be located at the head lining H. It is apparent to those skilled in the art that the point calculating unit 110 may be provided in other locations.

The method of controlling the heat-loss management system for the vehicle according to one foam of the present disclosure includes: the step of calculating the outdoor-air temperature of the vehicle and the vehicle speed through the outdoor-air calculating unit 120 and the vehicle-speed calculating unit 140, the step of deriving a comparative temperature value corresponding to the calculated outdoor-air temperature and vehicle speed through the data unit 150, the step of calculating the target temperature through the point calculating unit 110, and the step of determining the heat-insulation degree at a specific point in the vehicle by comparing the comparative temperature value with the target temperature in the control unit 200.

The outdoor-air temperature of the vehicle and the vehicle speed are calculated through the outdoor-air calculating unit 120 and the vehicle-speed calculating unit 140, and the data unit 150 derives a comparative temperature value corresponding to the calculated outdoor-air temperature of the vehicle and vehicle speed. Furthermore, the point calculating unit 110 calculates a target temperature at a specific point in the vehicle. In addition, the control unit 200 compares the comparative temperature value with the target temperature. If the comparative temperature value is different from the target temperature, the control unit 200 may determine that the heat-insulation degree at a specific point in the vehicle is lowered. Furthermore, if the comparative temperature is equal to the target temperature, the control unit 200 may determine that the heat-insulation degree at a specific point in the vehicle is maintained.

As having described, the present disclosure provides a heat-loss management system for a vehicle and a control method thereof which are capable of identifying a heat-insulation degree at a specific point in the vehicle so as to maintain or repair the heat-insulation performance of the vehicle.

Particularly, it is advantageous in that it is possible to continuously check the heat-insulation performance of the vehicle after the vehicle has been released.

Although exemplary forms of the present disclosure have been described for illustrative purposes, those skilled in the art will appreciate that various modifications, additions and substitutions are possible, without departing from the scope and spirit of the present disclosure.

What is claimed is:

1. A heat-loss management system for a vehicle, comprising:
a point calculating unit configured to calculate a target temperature that is a temperature at a specific point inside of the vehicle;
an outdoor-air calculating unit configured to calculate an outdoor-air temperature of the vehicle;
a vehicle-speed calculating unit configured to calculate a vehicle speed;
a data unit configured to store comparative temperature values corresponding to specific points and determined based on the outdoor-air temperature of the vehicle and the vehicle speed; and
a control unit configured to:
extract, through the data unit, a comparative temperature value among the stored comparative temperature values based on the calculated outdoor-air temperature and vehicle speed,
compare the extracted comparative temperature value with the calculated target temperature, and
determine a heat-insulation degree at the specific point inside of the vehicle.

2. The heat-loss management system according to claim 1, further comprising:
an indoor-air calculating unit configured to calculate an indoor-air temperature of the vehicle,
wherein the comparative temperature values are determined based on the outdoor-air temperature, the calculated indoor-air temperature of the vehicle and the vehicle speed.

3. The heat-loss management system according to claim 2, wherein the control unit is operated when the calculated indoor-air temperature is equal to a preset temperature.

4. The heat-loss management system according to claim 1, wherein the control unit is operated when the vehicle speed is equal to or less than a predetermined speed.

5. The heat-loss management system according to claim 1, wherein the data unit is configured to store the comparative temperature values in an initial release state of the vehicle.

6. The heat-loss management system according to claim 1, wherein the control unit is configured to determine that heat-insulation performance is deteriorated when a difference between the calculated target temperature and the extracted comparative temperature value is equal to or more than a preset level.

7. The heat-loss management system according to claim 6, wherein the control unit is configured to determine that the heat-insulation performance is deteriorated when the difference equal to or more than the preset level is detected a predetermined times or more.

8. The heat-loss management system according to claim 1, further comprising:
an alarm unit configured to alert a user of the vehicle when the controller determines that the heat-insulation performance is deteriorated.

9. The heat-loss management system according to claim 1, wherein the point calculating unit is configured to calculate target temperatures of at least one of a door joint, a door glass, a front pillar, a middle pillar, a rear pillar, a front shield glass, a rear shield glass, a head lining, or a sunroof of the vehicle.

10. A method of controlling a heat-loss management system for a vehicle, the method comprising:
calculating an outdoor-air temperature of the vehicle by an outdoor-air calculating unit,
calculating a vehicle speed by a vehicle-speed calculating unit;
deriving, by a data unit, a comparative temperature value, among comparative temperature values stored in a memory, based on the calculated outdoor-air temperature and vehicle speed;
calculating, by a point calculating unit, a target temperature; and
determining, by a control unit, a heat-insulation degree at a specific point inside of the vehicle by comparing the derived comparative temperature value with the calculated target temperature.
